(19) United States
(12) Patent Application Publication
(10) Pub. No.: US 2015/0165956 A1
(43) Pub. Date: Jun. 18, 2015

(54) HOIST ASSEMBLY FOR DUMP BODY

(71) Applicant: Caterpillar Inc., Peoria, IL (US)

(72) Inventors: Gowdhaman Sarangapani, Chennai (IN); Mohan R. Venu, Chennai (IN); Mathankumar Gunasekaran, Chennai (IN); Varun Sampathkumar, Chennai (IN)

(73) Assignee: Caterpillar Inc., Peoria, IL (US)

(21) Appl. No.: 14/631,859

(22) Filed: Feb. 26, 2015

(51) Int. Cl. B60P 1/16

(52) U.S. Cl. CPC B60P 1/16

(57) ABSTRACT

A hoist assembly for movable actuation of a dump body relative to a truck frame is disclosed. The dump body includes an underbody floor assembly with a first cross-member and a second cross-member. The first cross-member and the second cross-member are spaced apart from each other and are rectangular-shaped. The hoist assembly includes a cylinder assembly with a rod member movably positionable within a cylinder body. The cylinder body is coupled to the truck frame. A rod end mounting assembly includes a bracket member to distribute a weight of the dump body to the cylinder assembly. The bracket member includes a first end integrally and contiguously attached to two adjacent sides of the first cross-member, and a second end integrally and contiguously attached to two adjacent side of the second cross-member. Moreover, an end of the rod member is coupled to a center portion of the bracket member.

### TECHNICAL FIELD

The present disclosure relates generally to the mounting of a dump body to the frame of a dump truck. More specifically, the present disclosure relates to a hoist assembly that movably mounts the dump body to the frame and yields relatively low stress.

### BACKGROUND

In conventional dump trucks, a dump body is pivotally connected to a truck frame at a rear of the dump truck. Generally, a hydraulic cylinder is employed to apply pressure to lift or lower (or pivot) the dump body in relation to the truck frame. Such a configuration facilitates discharge of the contents of the dump body onto a dumpsite. Because of substantially heavy loads, dump bodies in modern dump trucks sustain considerably heavy stresses. Such stresses may affect associated hoist assemblies that assist the lowering and/or lifting operation of the dump body. Over a period, such stresses may cause deformations in the dump body structure and create weld failures on the hoist assembly, which results in an increase in machine downtime.

In further detail, a hoist assembly generally includes a pivotal connection to the truck frame on one end, while another end may be pivotally and slidably connected to the dump body, via a mounting assembly. A typical mounting assembly includes a bracket member that rests between two floor ribs, which are consecutively arranged cross-members welded on the floor assembly of the dump body structure. Such bracket members may wear out due to continued stress. More particularly, an interface between the bracket member and the underbody assembly may include welded joints, which may rupture as early as within 4000 to 8000 hours of operation of the dump truck. Each such occurrence requires procurement, repair, and/or re-fitment of new components, which involves additional effort, cost, and time.

Chinese Patent Application 102729877 A describes a bracket assembly for a front-end cylinder. Although the structure disclosed in this application may accommodate stresses in an associated operation, the apparent focus of the application relates to the reduction of wear arising out of friction during operations. Further, no solution is provided to effectively accommodate stresses associated with an operation of a dump body relative to a dump truck.

Accordingly, the system and method of the present disclosure solves one or more problems set forth above and/or other problems in the art.

### SUMMARY OF THE INVENTION

Various aspects of the present disclosure illustrate a hoist assembly for movable actuation of a dump body relative to a truck frame. The dump body includes an underbody floor assembly that defines a first cross-member and a second cross-member. The first cross-member is spaced apart from the second cross-member. Both the first cross-member and the second cross-member are generally rectangular-shaped. The hoist assembly includes a cylinder assembly that includes a rod member movably positionable within a cylinder body. The cylinder body is coupled to the truck frame and the rod member includes an end. A rod end mounting assembly includes at least one bracket member having a first end and a second end. The first end is integrally and contiguously attached to at least two adjacent sides of the first cross-member, while the second end is integrally and contiguously attached to at least two adjacent sides of the second cross-member. The bracket member includes a center portion, and the end of the rod member is connected to this center portion. Further, a weight of the dump body is distributed to the cylinder assembly via the connection of the bracket member with the cross-members of the underbody floor assembly.

### BRIEF DESCRIPTION OF THE DRAWINGS

FIG. 1 is a dump truck with a dump body incorporated with a hoist assembly, in accordance with the concepts of the present disclosure;

FIG. 2 is an enlarged sectional view of the encircled portion in FIG. 1, showing the hoist assembly in accordance with the concepts of the present disclosure;

FIG. 3 is a perspective view of an underneath portion of the dump body of FIG. 1, showing a bracket member of the hoist assembly, in accordance with the concepts of the present disclosure; and

FIG. 4 is a plan view of the bracket member of FIG. 3 with the cylinder removed to display bracket members attached to the dump body, in accordance with the concepts of the present disclosure.

### DETAILED DESCRIPTION

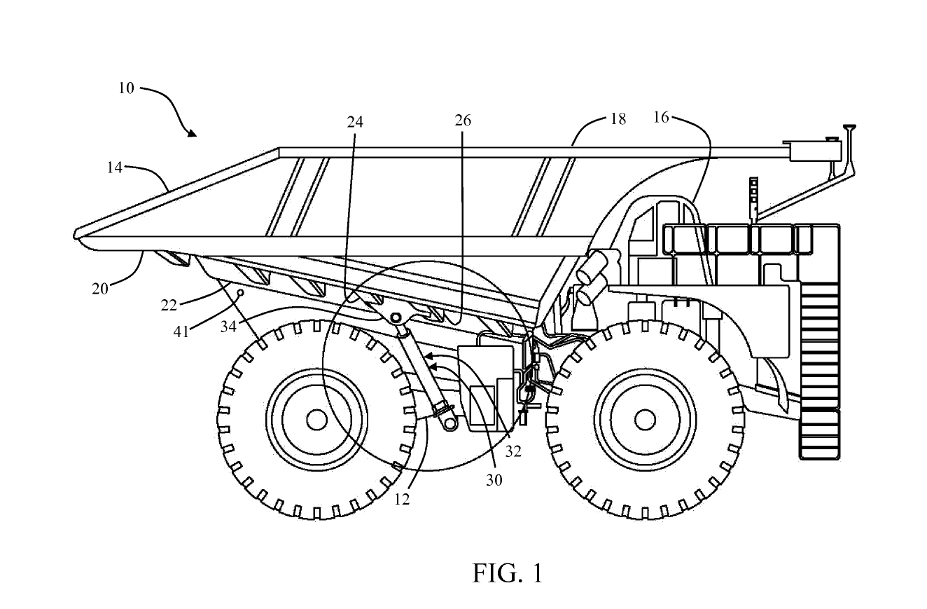

Referring to FIG. 1, shown is machine 10, which may be a dump truck, for example. The machine 10 includes a truck frame 12 and a dump body 14. As with commonly known dump trucks, the machine 10 may also include an operator cab 16, from which an operator may control movement of the dump body 14. Such motions may include lowering and lifting of the dump body 14 relative to the truck frame 12. Walls 18 of the dump body 14 may facilitate securement of a load during transportation.

The dump body 14 includes an underbody floor assembly 20 with an underbody surface 22. As part of the underbody floor assembly 20, a number of spaced apart cross-members or floor ribs, such as cross-members 24, 26 are arranged to generally run perpendicular relative to the walls 18 of the dump body 14 along the underbody surface 22 of the dump body 14. A pair of cross-members 24 and 26 (also referred to as first cross-member 24 and the second cross-member 26) is built within the underbody surface 22 of the dump body 14, as is customary. The machine 10 includes a hoist assembly 30, which facilitates a moveable actuation of the dump body 14, and involves the lifting and lowering of the dump body 14 relative to the truck frame 12.

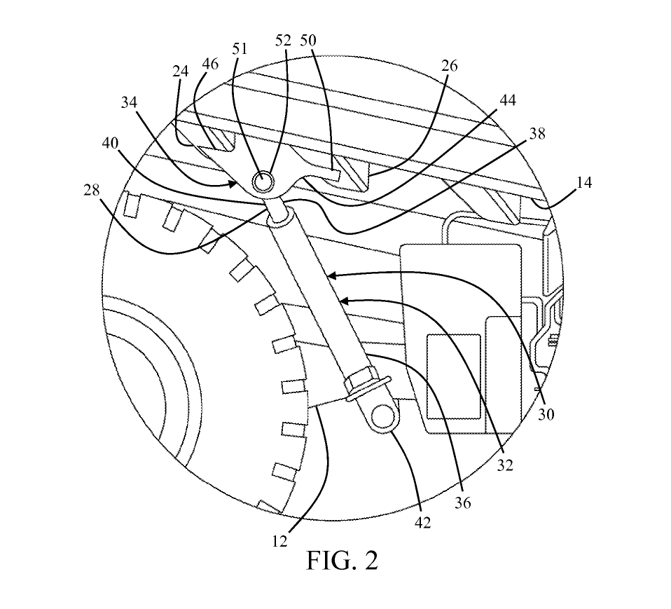

Referring to FIG. 2, the hoist assembly 30 includes a cylinder assembly 32 and a rod end mounting assembly 34, as shown. The cylinder assembly 32 includes a cylinder body 36, within which a piston assembly 28 having a rod member 38, extends and contracts within the cylinder body 36, as is customary. The rod member 38 includes an end 40, which is connected to the rod end mounting assembly 34. The cylinder assembly 32 has bottom end 42, which is pivotably coupled to the truck frame 12. As the cylinder assembly 32 is actuated (or pressurized) during operation, the rod member 38 extends outwardly from the cylinder body 36 and the dump body 14 tilts upwardly, pivoting about a hinge joint 41 (see FIG. 1), as is customary. This enables execution of a dumping action of the dump body 14.

As shown, the rod end mounting assembly 34 is mounted to the underside of the dump body 14 and interposed between the cylinder assembly 32 and the underbody floor assembly 20. The rod end mounting assembly 34 includes a bracket member 44 that includes a first end 46 and a second end 50. The first end 46 is connected to the first cross-member 24, while the second end 50 is connected to the second cross-member 26. Further, a center portion 51 of the bracket member 44 includes a pivot pin 52, which facilitates a pivotal connection between the rod member 38 and the bracket member 44. Additionally, the bracket member 44 may be substantially triangular shaped for structural rigidity and to withstand operational stresses.

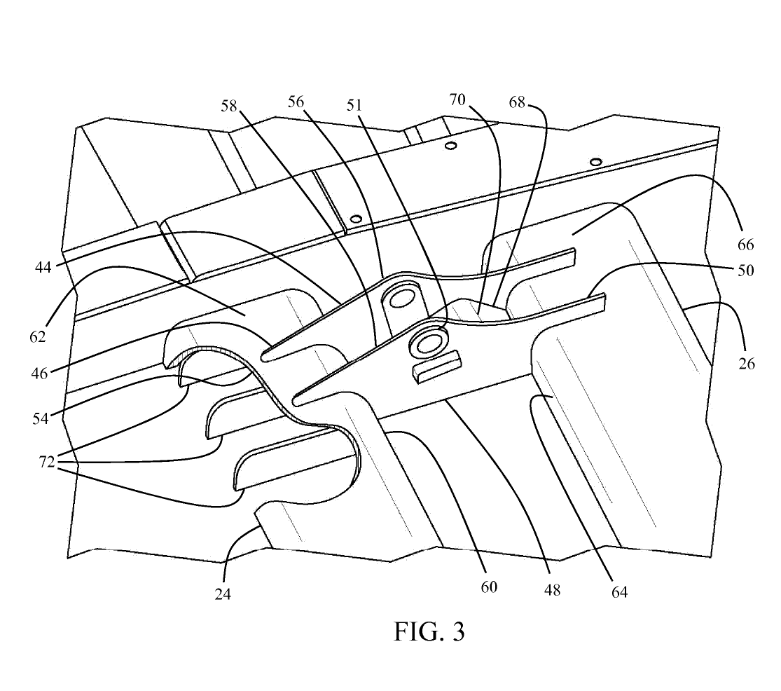

Referring to FIG. 3, an underbody perspective of the underbody floor assembly 20 is shown. More particularly, the bracket member 44 is positioned with the underbody floor assembly 20, but with the absence of the cylinder assembly 32. Given this absence, the contours and silhouettes of the bracket member 44 may be better visualized. Structurally, the bracket member 44 includes a first flange plate 56 and a second flange plate 58 (also referred to as flange plates 56 and 58). Also depicted are the cross-members 24 and 26 that are rectangular-shaped, although other shapes are contemplated. The cross-members 24 and 26 may be C-shaped in cross-section.

Both the flange plates 56 and 58 are planar components that are substantially triangular shaped, thus defining the profile of the bracket member 44. Moreover, both the flange plates 56 and 58 are suitably spaced apart and are parallel to each other. A connector plate 68 is interfaced substantially perpendicularly between the flange plates 56 and 58, inflexibly connecting the flange plates 56 and 58 together. A welded connection between the connector plate 68 and the flange plates 56 and 58 may be envisioned, although other connection means are possible. The connector plate 68 includes a bend 70 defined along a width of the bracket member 44 (or between the flange plates 56 and 58) to impart rigidity and strength to the bracket member 44. Such a feature is the principle behind the incorporation of ribs and/or stiffeners that aid in the production of relatively robust structures.

The first end 46 of the bracket member 44 includes an inverted L-shaped profile, which complements at least a partial overlay over the rectangular-shaped first cross-member 24. Similarly, the second end 50 of the bracket member 44 also includes an inverted L-shaped profile to complement an engagement and at least a partial overlay over the rectangular shaped second cross-member 26. More specifically, the first end 46 is integrally and contiguously attached to at least two perpendicularly configured adjacent sides (first member first side 60 and first member second side 62) of the first cross-member 24. Similarly, the second end 50 is integrally and contiguously attached to at least two perpendicularly configured adjacent sides (second member first side 64 and second member second side 66) of the second cross-member 26.

In an embodiment, the bracket member 44 is contiguously and integrally connected to additional sides of the cross-members 24 and 26 as well. As an example, if the cross-members 24 and 26 include a polygonal profile, which involves more sides than what has been depicted, it may be contemplated that an overlay of the bracket member 44 may extend to more than two sides of the cross-members 24 and 26. An overlay of the bracket member 44 may also be applicable to cross-member profiles that include arcuate and irregular configurations.

The bracket member 44 also includes a bracket base 48, which is connected to the underbody surface 22 of the dump body 14. Although not limited, this connection may be carried out by welding processes as already disclosed. In doing so, stress paths travel via an associated connection interface thus formed. The bracket structure, therefore, may be kept from undue deformation given the vibratory movements and strenuous activities associated with an operation of the dump body 14.

However, configurations of the bracket member 44, as discussed so far, may differ from application to application. Such difference may be contemplated given each application may involve variations in size, profile, shape, and placement of the truck frame 12, relative to the dump body 14. Further, specifications and load capacity of the machine 10 may vary as well, which may require an alteration to the overall characteristics, such as a thickness of the bracket member 44. Accordingly, the disclosed bracket member 44 is not intended to be limited to the disclosed embodiments alone.

Also depicted in FIG. 3 are gusset plates 72, which are exemplarily three in number. Although an incorporation of the gusset plates 72 is shown in the first cross-member 24, one may envision a similar incorporation to the second cross-member 26 as well. When multiple cross-members share an interface with the bracket member 44, such gusset plates 72 may be assembled within each of those cross-members as well. A variation to the number of gusset plates 72 may also be contemplated.

The gusset plates 72 are planarly shaped components that are positioned as a series within the cross-member 24 and 26. The gusset plates 72 extend from an underside 54 of the cross-members 24 and 26, to the underbody surface 22 of the dump body 14. The gusset plates 72 are positioned at substantial right angles to the first member first side 60 and first member second side 62. With this deployment, the gusset plates 72 impart strength to the cross-members 24 and 26, and help withstand deformative forces that act upon a related section of cross-members 24 and 26, while the dump body 14 is lifted or lowered. An addition to the number of gusset plates 72 and/or thicker gusset plates 72 may be envisioned, as already noted, however, this may depend upon a load carrying capacity of the dump body 14 and other known factors.

The flange plates 56 and 58, and the gusset plates 72 may be manufactured from steel billets, for example, that have been obtained from raw steel. Operable shapes and profiles may be subsequently formed by using processes such as rolling. This may be performed before a fabrication process is initiated. The characteristic shapes of the flange plates 56 and 58 may be established via shaping operations, milling operations, computer numerical control (CNC), and/or the like. Other materials and methods of manufacture may also be contemplated.

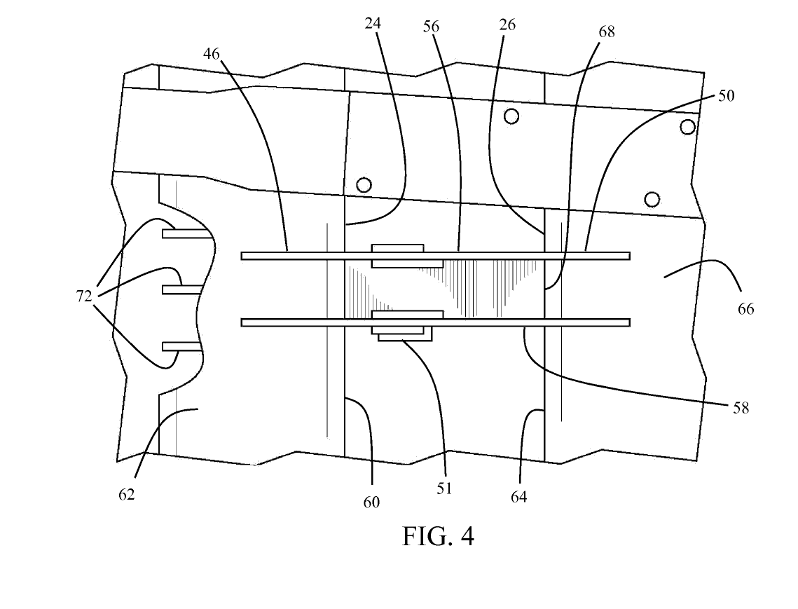

Referring to FIG. 4, a bottom view of the dump body 14, installed with the bracket member 44 alone, is depicted. More particularly, the extent to which the first end 46 and a second end 50 overlay the cross-members 24 and 26, may be more clearly seen. A placement pattern of the gusset plates 72 relative to the bracket member 44 (or to each of the flange plates 56 and 58), may also be understood. As shown, each gusset plate 72 may occupy a region that falls in alternate succession to the position of the flange plates 56 and 58. In that way, a wider surface area may sustain load, thus facilitating a relatively better distribution of associated stresses. Moreover, the bracket member 44 refrains from interfering into a related weld stress zone with this configuration.

### INDUSTRIAL APPLICABILITY

While in operation, as the cylinder assembly 32 is actuated (or pressurized), the rod member 38 extends outwards from the cylinder body 36. As a result, the dump body 14 tilts upwards, while pivoting about the hinge joint 41 to deliver a load. An overlay of the bracket member 44 to the cross-members 24 and 26 at each of the first end 46 and second end 50 assists the hoist assembly 30 to accommodate considerable stress and vibrations of such a load haul and dumping action. This relative improvement in stress management is because of an increase in the interface area (or a surface area of the connection) between the bracket member 44 and the cross-members 24 and 26. Therefore, associated stress paths travel via the connection interface with relative ease.

The above noted concepts of the bracket member 44 demonstrate at least one of rigidity, strength, and resilience. The overlay of the bracket member 44 over the rectangular-shaped profiles of the cross-members 24 and 26 may be characteristic to this requirement. This is because the perpendicularly configured adjacent sides 60 and 62 of the first cross-member 24, and the perpendicularly configured adjacent sides 64 and 66 of the second cross-member 26, generally produce rigid structures. Given the triangularly shaped bracket member 44, and by having the first end 46 and second end 50 respectively and contiguously integrate into the adjacent sides 60 and 62, and the adjacent sides 64 and 66, the hoist assembly 30 is further supplemented with rigidity. This configuration may distribute stress substantially evenly to the parent body (underbody floor assembly 20 and hoist assembly 30), when subjected to a load. In effect, a weight of the dump body 14 is distributed relatively well to the cylinder assembly 32 (or the hoist assembly 30) via the disclosed arrangement of the bracket member 44 with the cross-members 24 and 26, and the underbody floor assembly 20.

Therefore, the bracket member 44 yields relatively low stress, which in turn limits deformation, fractures, and weld failures. Additionally, this configuration considerably relieves the underbody floor assembly 20 of operational stresses as well. This may result in prolonged life of associated components, lesser repairs, lower costs, and an optimized lead-time.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A hoist assembly for movable actuation of a dump body relative a truck frame, the dump body including an underbody floor assembly defining a first cross-member and a second cross-member, the first cross-member being spaced apart from the second cross-member, wherein both the first cross-member and the second cross-member being generally rectangular-shaped, the hoist assembly comprising:
a cylinder assembly including a rod member movably positionable within a cylinder body, the cylinder body being coupled to the truck frame and the rod member defining an end; and
a rod end mounting assembly including:
at least one bracket member having a first end and a second end, the first end being integrally and contiguously attached to at least two adjacent sides of the first cross-member, while the second end being integrally and contiguously attached to at least two adjacent side of the second cross-member, the at least one bracket member defining a center portion thereof,
wherein the end of the rod member being coupled to the center portion of the at least one bracket member, whereby weight of the dump body being distributed to the cylinder assembly through the at least one bracket member connected with the first cross-member and the second cross-member and with the underbody floor assembly.
